(19) United States
(12) Patent Application Publication
(10) Pub. No.: US 2005/0039169 A1
(43) Pub. Date: Feb. 17, 2005

(54) Integrated source code debugging apparatus method and system

(76) Inventors: Yu-Cheng Hsu, Tucson, AZ (US); Louis Rasor, Tucson, AZ (US)

Correspondence Address: KUNZLER & ASSOCIATES, 8 EAST BROADWAY, SUITE 600, SALT LAKE CITY, UT, 84111, US

(21) Appl. No.: 10/641,377

(22) Filed: Aug. 14, 2003

(51) Int. Cl. G06F 9/44

(52) U.S. Cl. 717/124

(57) ABSTRACT

An apparatus for debugging source code includes a source code debugger configured to display state information and one or more initialization routines corresponding to a particular software function. The initialization routines initialize a target environment to a particular system state and facilitate replication, isolation, and analysis of software coding errors. In one embodiment, a function selector facilitates selection of the target function by a user and generates an execution request. In turn, a task dispatcher dispatches the initialization routines and associated software function in response to the execution request. The present invention greatly simplifies interactive debugging of source code. Rather than generating complex, error-prone, and often timing-dependent manipulation sequences of registers, memory, peripheral devices, and the like, a user simply selects the initialization routines that generate the particular states and conditions necessary to replicate and analyze a particular software error.

### BACKGROUND OF THE INVENTION

1. Field of the Invention

The present invention relates to program code development. Specifically, the invention relates to apparatus, methods, and systems for debugging source code on complex target platforms.

2. Description of the Related Art

Advances in semiconductors and other computer-related technologies have dramatically increased the computing capacity available to computer-based systems while also fueling a corresponding increase in the size and complexity of the software executed thereon. As a result of the increased power, computer-based systems are required to handle an increasing variety of tasks. For example, computer-based systems are now relied upon for real-time and mission critical applications such as air traffic control, communications, industrial process control, and the like.

Many programs consist of thousands or even millions of lines of source code. The sheer volume of program codes greatly increases the potential for unanticipated side effects commonly known as ‘bugs’. Furthermore, as a result of the size of most computer programs, the source code is often developed by multiple teams of programmers working on different portions or aspects of the program. Each team or individual therein may accomplish similar tasks in a different manner or otherwise produce software that is incompatible with software developed by other teams.

Given the many forms of individual expression and the complexity of many applications, developing source code is often an error prone process that requires considerable design and testing to ensure software quality and reliability. For example, software developers are often required to anticipate a variety of system states and conditions many of which are not obvious and occur infrequently. The conditions and system states to which a program must correctly respond may be timing-dependent or hardware-dependent. Consistent anticipation of all the conditions, states, and dependencies to which program code must respond to remains an elusive challenge of software development tools and methods.

Despite the challenges of software development, the diverse environments in which computer-based systems operate require highly reliable robust software than can recover gracefully from unanticipated states and conditions. Due to the increasing reliance on computer software injust about every aspect of society, finding and eliminating software coding errors has become increasingly important to system usefulness and commercial viability.

“Debugging” is a commonly used term that refers to the process of finding and eliminating coding errors. One form of conventional debugging is often referred to as “interactive debugging” or “source code debugging.” Interactive debugging is typically conducted with a visually oriented “source code debugger” that displays program source code to the developer and facilitates stepping through the program source code while displaying the state of the computer's processor and associated memory to the developer.

To facilitate real time processing conditions, most source code debuggers include the ability to set a “break point” at a specific line of code such as the entry point to a specific function. Once a break point is encountered, the source code debugger halts further execution and thereby facilitates inspection of the computing system. Once at the break point, the developer may “single step” through each line of source code to assess if the program is responding correctly to the conditions and state of the computing system. Despite the tremendous inspection power provided by interactive debugging techniques, providing the stimulus and environment essential to generating a specific system state corresponding to a software error remains problematic.

Currently, software developers and testers use a variety of ad hoc methods and procedures in order to manipulate the computing environment into a system state that reveals a software coding error. For example, a software developer may receive reports from one or more customers indicating that a particular application “crashed” (i.e. failed) within a specific software function. The developer may then attempt to recreate the failure by providing the precise stimulus and inputs that bring the system to the particular internal state that crashes the system. Alternately, in lieu of external stimulus and inputs, the developer may manually change registers and memory locations to bring the system to the particular state that replicates the failure. While commonly used, such techniques are often tedious, error prone, and ineffective in replicating the faulty system state.

Given the aforementioned challenges, what is needed is a more systematic and automatic approach to generating particular system and environmental states corresponding to coding errors. Such an approach would increase the speed and effectiveness of interactive software debugging, resulting in more robust and reliable software in a variety of computing environments.

### BRIEF SUMMARY OF THE INVENTION

The present invention has been developed in response to the present state of the art, and in particular, in response to the problems and needs in the art that have not yet been fully solved by currently available software debugging means and methods. Accordingly, the present invention has been developed to provide an apparatus, method, and system for debugging source code that overcome many or all of the above-discussed shortcomings in the art.

In one aspect of the present invention, an apparatus for debugging source code includes a source code debugger configured to display state information and one or more initialization routines configured to initialize a target environment to a particular state. The initialization routines may correspond to a particular target function and may be executed previous to executing a selected target function in order to debug the selected target function under selected states, conditions, and target environments.

In addition to the aforementioned elements, the apparatus for debugging source code may also include a function selector configured to generate an execution request and a task dispatcher configured to dispatch the initialization routines in response to an execution request. In certain embodiments, the function selector generates the execution request in response to selection of the target function by a user.

In one embodiment, the function selector is compiled into the application source code and is displayed on the target platform. In another embodiment, the function selector is integrated into the source code debugger (either on the target platform or on a host,) which sends a message to the task dispatcher to initiate execution of the selected initialization routines and target function within the target environment.

The target environment state generated by the initialization routines may correspond to an application error or error condition. In certain embodiments, the target environment state is generated using information collected from an actual deployed environment. Using information collected from an actual deployed environment facilitates faithful replication of a particular state and associated error conditions.

In one embodiment, the apparatus for debugging source code is equipped with function-independent initialization routines and function-dependent initialization routines. The function-independent initialization routines generate states and conditions that are independent of a particular routine such as a particular system scenario. The function-dependent initialization routines generate states and conditions unique to a particular target function such as data structures passed as parameters to the particular target function.

In another aspect of the present invention, a method for debugging source code includes dispatching at least one initialization routine corresponding to a target function, dispatching the target function, and displaying state information within a source code debugger. The initialization routines initialize the target environment to a particular state. The method may also include collecting state information from a deployed environment and/or collecting state information in response to an application error.

In certain embodiments, dispatching the initialization routines involves dispatching one or more function-independent initialization routines and one or more function-dependent initialization routines. The method may also include recompiling kernel-mode code into user-mode code to facilitate debugging and single stepping through a dispatched target function such as a target function that invokes kernel-mode microcode.

In another aspect of the present invention, a system for debugging source code includes a target environment comprising a target platform including an operating system and a target application, a source code debugger configured to display state information, and one or more initialization routines that initialize the target environment to a particular state. The initialization routines may correspond to a particular target function within the target application. In one embodiment, the user selects the initialization routines and associated target function in order to debug the target function in a particular target environment and associated states and conditions.

The various elements and aspects of the present invention greatly simplify source code development. Rather than generating complex error-prone and often timing-dependent manipulation sequences of registers, memory, peripheral devices, or the like, a user simply selects the initialization routines that generate the particular states and conditions necessary to replicate, isolate, and analyze a particular software error. These and other features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram illustrating one embodiment of a prior art software development system;

FIG. 2 is a block diagram illustrating one embodiment of a software development system of the present invention;

FIG. 3 is a block diagram illustrating one embodiment of a debugging module of the present invention; and

FIG. 4 is a flow chart diagram illustrating one embodiment of a source code debugging method of the present invention.

### DETAILED DESCRIPTION OF THE INVENTION

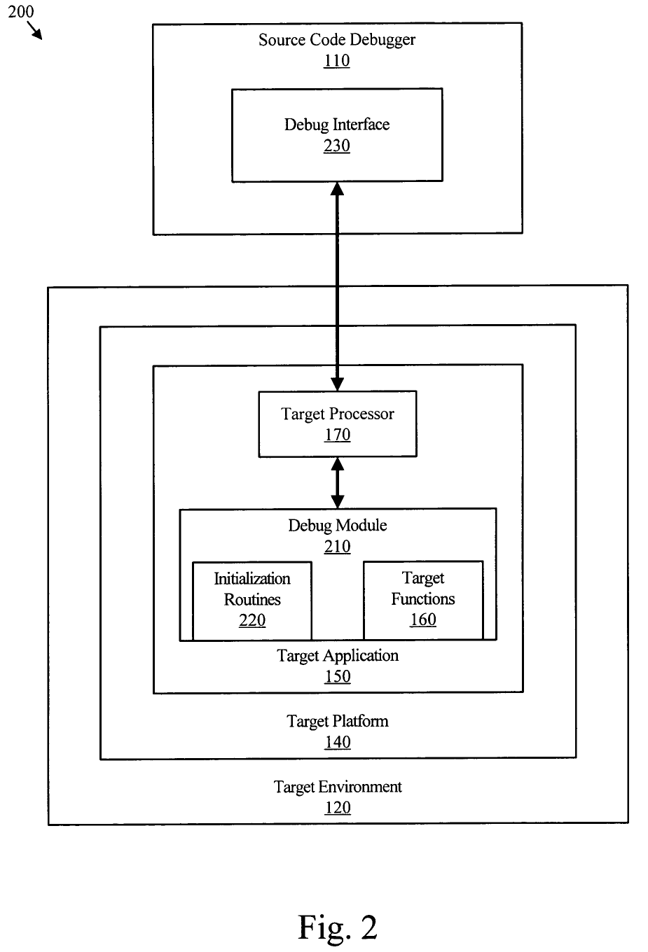

It will be readily understood that the components of the present invention, as generally described and illustrated in the Figures herein, may be arranged and designed in a wide variety of different configurations. Thus, the following more detailed description of the embodiments of the apparatus, method, and system of the present invention, as represented in FIGS. 2 through 4, is not intended to limit the scope of the invention, as claimed, but is merely representative of selected embodiments of the invention.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

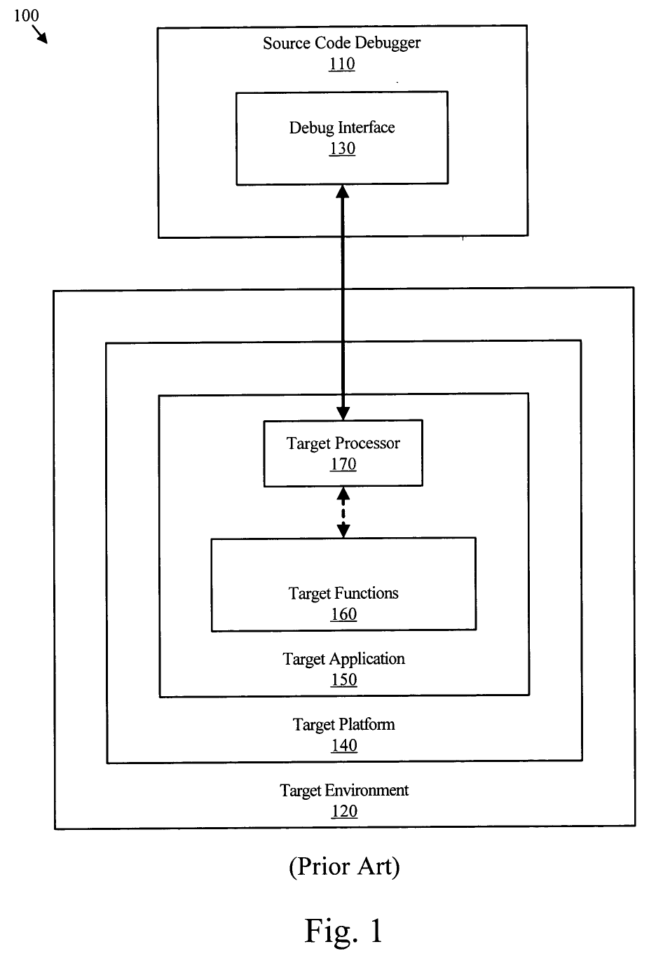

FIG. 1 is a block diagram illustrating one embodiment of a prior art software development system 100. The depicted prior art software development system 100 includes a source code debugger 110 and a target environment 120. The depicted source code debugger includes a debug interface 130, while the depicted target environment 120 includes a target platform 140, a target application 150, one or more target functions 160, and a target processor 170. A detailed description of the prior art software development system 100 is included in this specification in order to depict an exemplary environment in which the present invention may be deployed and to contrast the present invention with the prior art in a detailed manner.

As depicted, the source code debugger 110 facilitates inspection and control of the target processor 170 via the debug interface 130. Typically, various edit fields corresponding to source code variables and data structures and registers on the target processor 170, are displayed on the debug interface 130.

The source code debugger 110 and the debug interface 130 may reside on the target platform 140 or on a host (not shown) in communication with the target platform 140. In certain embodiments, the source code debugger 110 is a separate process on the target platform 140 under control of the debug interface 130. In other embodiments, the source code debugger 110 resides on a host and communicates with the target platform 140 via an emulator (not shown) that also functions as the target processor 170.

The control provided by the source code debugger 110 is limited in that access to system state information is typically restricted to displaying and manipulating processor register values, source code variables and data structures, and memory locations. However, the states and conditions to which software program codes must respond may include the state of peripheral devices—such as registers contained therein—that are not memory mapped and therefore not readily accessible via the debug interface 130. In addition, even when accessible, the amount of state information involved may prove prohibitive to effective development, particularly in light of entry errors typical of user-entered data.

From the above discussion, it can be readily appreciated that a need exists for improved means and methods that facilitate automated initialization of a target environment to a particular system state in order to facilitate isolation and analysis of software errors. Such means and methods would increase the speed and effectiveness of software development in general and software debugging in particular.

FIG. 2 is a block diagram illustrating one embodiment of a software development system 200 of the present invention. As depicted, the software development system 200 includes a debug module 210, a set of initialization routines 220, and a debug interface 230, in addition to many of the elements included in the prior art software development system 100, such as the source code debugger 110, the target functions 160, and the target processor 170. The software development system 200 addresses many of the previously mentioned limitations of the prior art.

The initialization routines 220 initialize the target processor 170 to a particular state. In addition, the initialization routines 220 may also initialize elements of the target environment 120—such as the target application 150, the target platform 140, and peripheral devices associated therewith—to a particular state useful for isolating and analyzing software errors or the like. In order to control the states and conditions to which a target function 160 must respond, one or more initialization routines 220 may be invoked just previous to invocation of the target function 160.

The initialization routines 220 may be custom developed by a developer to generate a specific state corresponding to an anticipated or discovered condition. Custom development facilitates changing state information not readily accessible via the debug a interface of a source code debugger. In addition to anticipated or discovered conditions, the initialization routines 220 may include state information collected from actual deployed systems such as deployed systems in which an error was detected.

In one embodiment, the initialization routines 220 comprise function-independent initialization routines that may be invoked in conjunction with any target function 160, as well as one or more function-dependent initialization routines intended to be invoked with specific target functions 160. The function-independent initialization routines may generate states and conditions that are independent of a particular routine such as a particular system scenario. The function-dependent initialization routines may generate states and conditions unique to a particular target function, such as data structures passed as parameters to the particular target function.

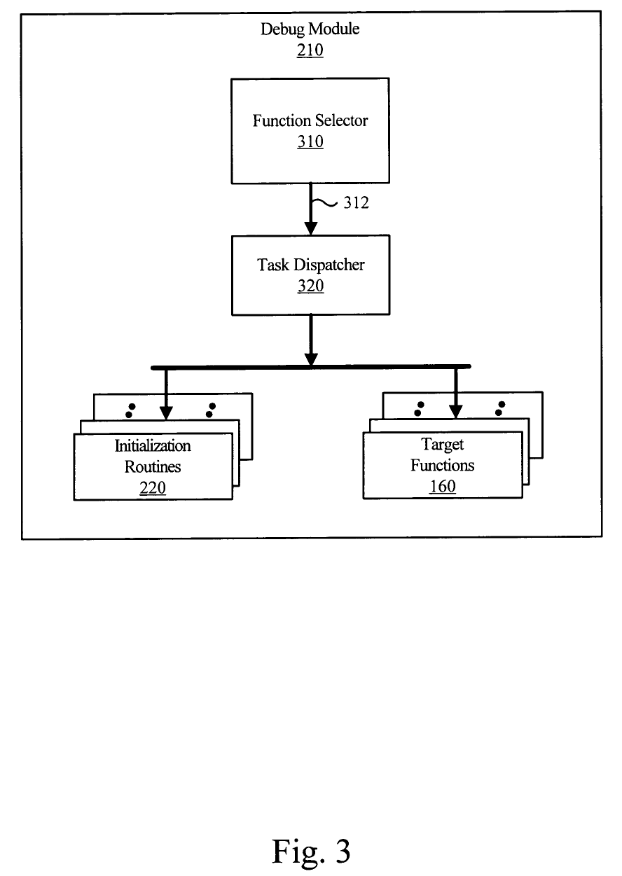

FIG. 3 is a block diagram illustrating in greater detail one embodiment of the source code debugging module 210 of the present invention. The depicted source code debugging module 210 includes a function selector 310, a task dispatcher 320, a set of initialization routines 220, and a corresponding set of target functions 160. The source code debugging module 210 reduces the complexity of replicating software errors when debugging source code.

The function selector 310 facilitates selection of a target function 160 that is to be invoked within a target application such as the target application 150 depicted in FIGS. 1 and 2. In one embodiment, selection of a target function generates an execution request 312 that is sent to the task dispatcher 320. In response to the execution request 312, the task dispatcher 320 dispatches one or more initialization routines 220 previous to dispatching a selected target function 160. In one embodiment, the debug interface 230 includes one or more entry fields that specify the dispatch timing of the initialization routines 220 and the selected target function 160. The ability to specify the dispatch timing facilitates replication of timing-dependent software errors.

In one embodiment, the function selector 310 and the task dispatcher 320 are compiled into a user-mode version of the target application 150. Compilation into a user-mode version of the target application 150 facilitates source code debugging of kernel-mode code such as kernel-mode microcode. In another embodiment, the function selector 310 is integrated into the source code debugger 110, and the task dispatcher 320 is distributed on both the source code debugger 110 and the target application 150.

The depicted source code debugging module 210 leverages the programming power available within a source code development system to the challenges of testing and debugging software code and provides power and flexibility currently not found in integrated debugging environments.

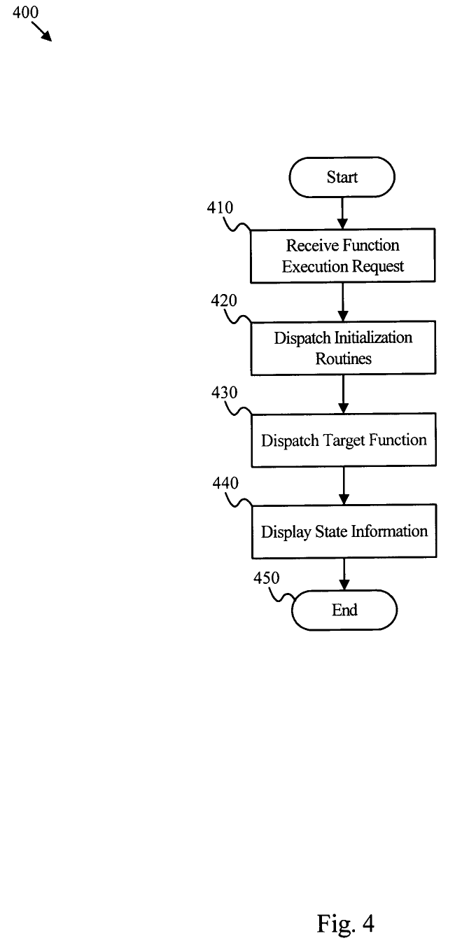

FIG. 4 is a flow chart diagram illustrating one embodiment of a source code debugging method 400 of the present invention. The source code debugging method 400 may be conducted in conjunction with the debug module 210 depicted in FIGS. 2 and 3, or may be conducted independent thereof. The source code debugging method 400 includes a receive request step 410, a dispatch initialization routines step 420, a dispatch target function step 430, and a display state information step 440. The depicted method 400 may be used to test, analyze and improve software performance during many phases of software development including the prototyping, coding, testing, and maintenance phases of software development.

The receive request step 410 receives a function execution request such as the execution request 312 generated by the function selector 310 depicted in FIG. 3. Once received, the method proceeds to the dispatch initialization routines step 420 whereupon one or more initialization routines are dispatched that generate a particular state. In one embodiment, the initialization routines are hardwired to the selected function. In another embodiment, the initialization routines are user selectable.

The dispatch target function step 430 dispatches a target function such as one of the target functions 160 depicted in FIGS. 1-3. In one embodiment, dispatch timings for the dispatch initialization routines step 420 and the dispatch target function step 430 are selected by the user via interface controls on the debug interface 230.

The display state information step 440 displays state information to a user, such as a software developer, a software tester, a service technician, or the like. In one embodiment, the state information is displayed in a custom manner by display functions included in the target application 150. In another embodiment, the state information is displayed on the debug interface 130.

The present invention facilitates software development and testing in general and isolation, replication, and analysis of software errors in particular. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus for debugging source code, the apparatus comprising:
a source code debugger configured to display state information; and
at least one initialization routine configured to initialize a target environment to a particular state, the at least one initialization routine corresponding to a target function within a target application.

2. The apparatus of claim 1, further comprising a task dispatcher configured to dispatch the at least one initialization routine in response to an execution request.

3. The apparatus of claim 1, further comprising a function selector configured to generate an execution request in response to selection of the target function by a user.

4. The apparatus of claim 3, wherein the function selector is integrated into the source code debugger.

5. The apparatus of claim 1, wherein the particular state corresponds to an application error.

6. The apparatus of claim 1, further comprising a deployed system configured to dump information used to initialize the target environment to the particular state.

7. The apparatus of claim 1, wherein the at least one initialization routine comprises a function-independent initialization routine and a function-dependent initialization routine.

8. The apparatus of claim 1, wherein the source code debugger is further configured to single step through the target function.

9. A method for debugging source code, the method comprising:
dispatching at least one initialization routine corresponding to a target function, the at least one initialization routine configured to initialize a target environment to a particular state;
dispatching the target function; and
displaying state information within a source code debugger.

10. The method of claim 9, further comprising collecting state information from a deployed environment.

11. The method of claim 9, further comprising collecting state information in response to an application error.

12. The method of claim 9, wherein dispatching the at least one initialization routine comprises dispatching a function-independent initialization routine and a function-dependent initialization routine.

13. The method of claim 9, further comprising single stepping through the target function.

14. The method of claim 9, further comprising recompiling kernel-mode code into user-mode code.

15. An apparatus for debugging source code, the apparatus comprising:
means for dispatching at least one initialization routine corresponding to a target function, the at least one initialization routine configured to initialize a target environment to a particular state;
means for dispatching the target function; and
means for displaying state information.

16. The apparatus of claim 15, further comprising means for collecting state information from a deployed environment.

17. The apparatus of claim 15, further comprising means for collecting state information in response to an application error.

18. The apparatus of claim 15, further comprising means for single stepping through the target function.

19. A system for debugging source code, the system comprising:
a target environment comprising a target platform including an operating system and a target application;
a source code debugger configured to display state information; and
at least one initialization routine configured to initialize the target environment to a particular state, the at least one initialization routine corresponding to a target function within the target application.

20. The system of claim 19, further comprising a deployed system configured to provide information used to initialize the target environment to the particular state.

21. A computer readable storage medium comprising computer readable program code for debugging source code, the program code configured to conduct a method comprising:
enabling selection of a target function;
dispatching at least one initialization routine corresponding to the target function, the at least one initialization routine configured to initialize a target environment to a particular state; and
dispatching the target function.

22. The computer readable storage medium of claim 21, wherein the method further comprises collecting state information from a deployed environment.

23. The computer readable storage medium of claim 21, wherein the method further comprises collecting state information in response to an application error.

24. The computer readable storage medium of claim 21, wherein dispatching the at least one initialization routine comprises dispatching a function-independent initialization route and a function-dependent initialization routine.

25. The computer readable storage medium of claim 21, wherein the method further comprises single stepping through the target function.

26. The computer readable storage medium of claim 21, wherein the method further comprises recompiling kernel-mode code into user-mode code
